(19) United States
(12) Patent Application Publication
(10) Pub. No.: US 2011/0025674 A1
(43) Pub. Date: Feb. 3, 2011

(54) DISPLAY SYSTEM

(76) Inventors: Chun-Yi Lien, Taipei City (TW); Chen-Chu Lin, Taipei City (TW); Yu-Chun Liu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/845,775

(22) Filed: Jul. 29, 2010

(30) Foreign Application Priority Data
Jul. 30, 2009 (TW) 098125665

(51) Int. Cl. G09G 5/00

(52) U.S. Cl. 345/211

(57) ABSTRACT

A display system includes an electronic device, a display device, a power line and two converters. The electronic device is used to provide image data, and the display device displays images according to the image data. The first converter is coupled to the electronic device and plugged to a first power socket for receiving the image data sent by the electronic device and power from the power line, combining image signal and power signal and transmitting the combined signal to a second converter via the power line. The second converter is coupled to the display device and plugged to a second power socket for receiving the power from the power line and the image data sent by the first converter and separating the signal to transmit the image data to the display device.

### BACKGROUND OF THE INVENTION

1. Field of the Invention

The invention relates to a display system and, more particularly, to a display system which transmits image data via a power line.

2. Description of the Related Art

With the development of information technology and multi-media technology, users usually store mass image data via various electronic devices in daily life, and then process image data via a display device. For example, when in a meeting or a presentation, the speaker may use a projector to project the image data stored in a notebook computer on a screen to facilitate the discussion.

Generally, the electronic device outputs the image data via a specific interface, and then transmits the image data to the display device via a cable. The display device may directly display the image (such as using a liquid crystal display (LCD) screen) or project the image (such as using the projector). An analog display system uses analog signal interfaces such as a D-subminiature (D-sub) interface or a composite video broadcast signal (CVBS) interface, and a digital display system uses digital signal interfaces such as a high definition multimedia interface (HDMI) or a digital visual interface (DVI). In the conventional display system, the power cable and the signal cable are independent of each other. The electronic device and the display device are connected to the power cable and the signal cable with different connecting ports according to different video interface specifications. In another aspect, the power for the display equipment is usually directly provided via the power line.

FIG. 1 is a schematic diagram showing a conventional display system 100. The display system 100 includes an electronic device 10 (such as a personal computer), a display device 20 (such as a projector) and cables C_{AC1} and C_{AC2}. The specification of C_{AC1} varies along with the specification of the image output terminal of the electronic device 10. For example, when the connector of the image output terminal of the electronic device 10 is a video graphics array (VGA) connector, the cable C_{AC1} is also the VGA cable. The electronic device 10 includes a power input terminal P1 which may be coupled to the power socket 41 via the cable C_{AC2} to receive the power and an image output terminal Q1 which may output the image data via the cable C_{AC1}. The display device 10 includes a power input terminal P2 and an image input terminal Q2, which may be coupled to the power socket 42 to receive the power via the cable C_{AC1}.

In different practical applications, the architecture of devices in the display system 100 may be different. An extension cable C_{AC1} is usually needed to transmit the images between the electronic device 10 and the display device 20. As a result, not only the cable is not easily laid, but also the display quality is affected due to the signal attenuation. In addition, some kinds of electronic devices 10 may not be detected correctly.

### BRIEF SUMMARY OF THE INVENTION

The invention discloses a display system including an electronic device, a first converter, a second converter and a display device. The electronic device is used to output an image data. The first converter is plugged to a first socket and coupled to the electronic device for receiving image data sent by the electronic device and adding the image data to the power line to transmit the image data via the power line. The second converter is plugged to the second socket for receiving the power and image data transmitted from the power line, separating the power and the image data and outputting the image data. The display device is coupled to the second converter for receiving the image data outputted by the second converter and displaying the image data.

### BRIEF DESCRIPTION OF THE DRAWINGS

FIG. 1 is a block diagram showing a conventional display system;

FIG. 2 is a block diagram showing the display system in a first embodiment of the invention;

FIG. 3 is a block diagram showing the display system in a second embodiment of the invention; and

FIG. 4 and FIG. 5 are schematic diagrams showing the converter in embodiments of the invention.

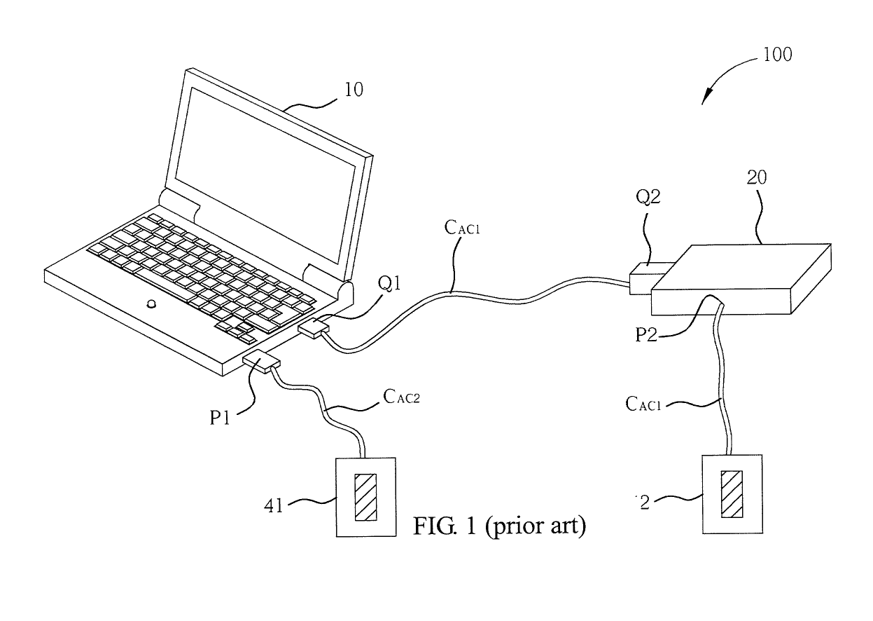

### DETAILED DESCRIPTION OF THE EMBODIMENTS

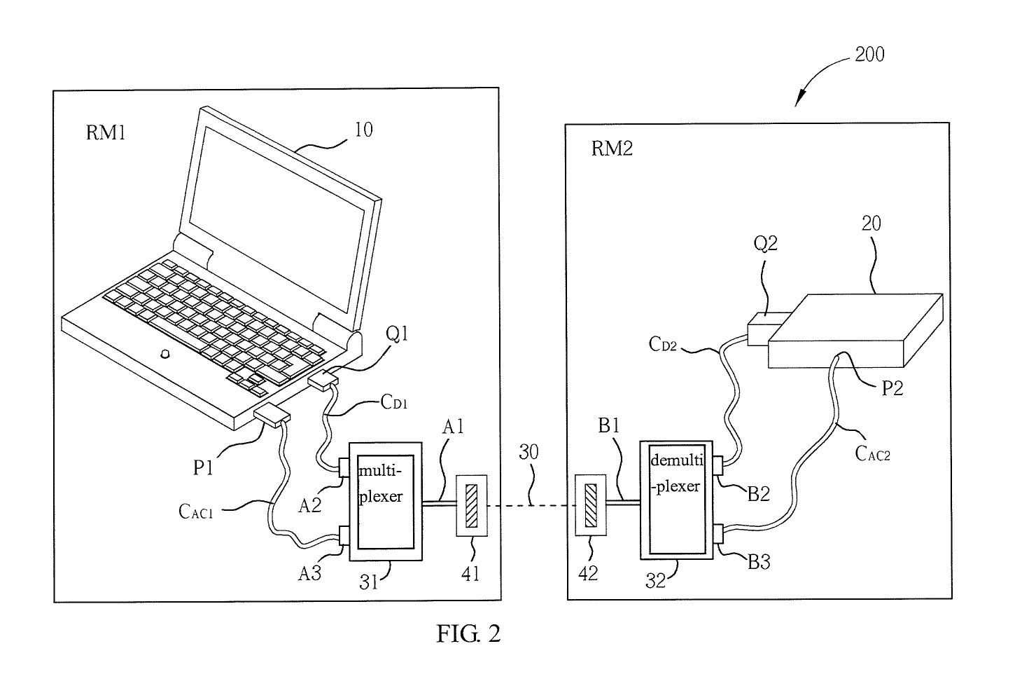

FIG. 2 is a block diagram showing a display system 200 in the first embodiment of the invention. The display system 200 includes an electronic device 10 (such as a personal computer), a display device 20 (such as a projector), a power line 30, two converters 31 and 32, two power sockets 41 and 42 and cables C_{AC1}, C_{AC2}, C_{D1} and C_{D2}. In a common family, the electronic device 10 and the display device 20 may be disposed in two rooms RM1 and RM2, respectively. The two rooms have the power sockets 41 and 42, respectively, to receive the power signal of the power line 30. The converter 31 may be a three-terminal element (denoted by A1 to A3 in FIG. 2), and the converter 32 also may be a three-terminal element (denoted by B1 to B3 in FIG. 2). The function and structure of the converters 31 and 32 are detailed illustrated hereinafter. The electronic device 10 includes an image output terminal Q1 (such as a VGA port or a DVI port of the personal computer) and a power input terminal P1. The power input terminal P1 is coupled to the A3 terminal of the converter 31 via the cable C_{AC1} to receive the power from the power line 30. The image output terminal Q1 is coupled to the A2 terminal of the converter 31 via the cable C_{D1} to transmit the image data. The display device 20 includes a power input terminal P2 and an image input terminal Q2. The power input terminal P2 is coupled to the B3 terminal of the converter 32 via the cable C_{AC2} to receive the power of the power line 30, and the image input terminal Q2 is coupled to the B2 terminal of the converter 32 via the cable C_{D2} to receive the image data provided by the electronic device 10. The converter 31 is plugged in the socket 41 via the A1 terminal, and the converter 32 is plugged in the socket 42 via the B1 terminal. The sockets 41 and 42 are connected to each other via the power line 30.

In the first embodiment of the invention, the converter 31 is a multiplexer, and the converter 32 is a demultiplexer. Therefore, in the display system 200 of the invention, the converter 31 receives the image data sent by the electronic device 10, adds the image data to the power signal, and then transmits the power and the image data via the power line 30. In another aspect, the converter 32 receives the power signal and the image data transmitted from the power line 30 and separates the power signal and the image data. Therefore, the power signal and the image data can be transmitted to the power input terminal P2 and the image input terminal Q2 of the display device 20, respectively. The invention is not limited to the embodiment in FIG. 2.

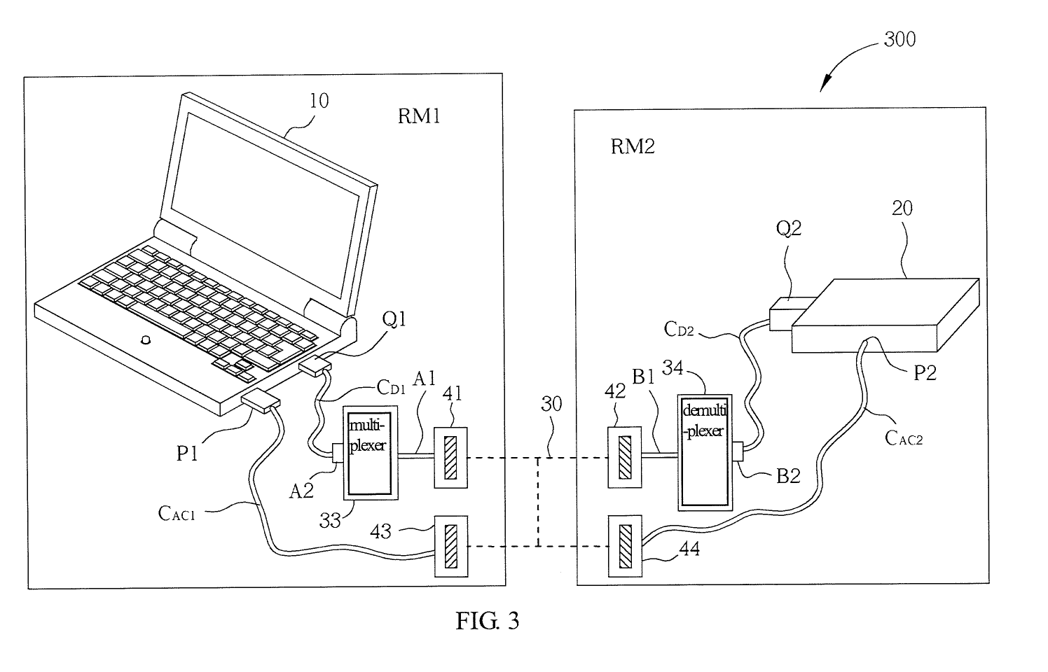

FIG. 3 is a block diagram showing the function of the display system 300 in the second embodiment of the invention. The display system 300 includes an electronic device 10 (such as a personal computer), a display device 20 (such as a projector), a power line 30, two converters 33 and 34, four power sockets 41, 42, 43 and 44 and cables C_{AC1}, C_{AC2}, C_{D1} and C_{D2}. In a common family, the electronic device 10 and the display device 20 may be disposed in two rooms RM1 and RM2, respectively. The room RM1 has the power sockets 41 and 43 to receive the power signal from the power line 30. The room RM2 has the power sockets 42 and 44 to receive the power signal from the power line 30. The converter 33 may be a two-terminal element (denoted by A1 and A2 in FIG. 3), and the converter 34 also may be a two-terminal element (denoted by B1 and B2 in FIG. 3). The function and structure of the converters 33 and 34 are illustrated hereinafter. The electronic device 10 includes an image output terminal Q1 (such as the VGA port or the DVI port of the personal computer) and a power input terminal P1. The power input terminal P1 is coupled to the socket 43 via the cable C_{AC1} to receive the power from the power line 30. The image output terminal Q1 is coupled to the A2 terminal of the converter 33 via the cable C_{D1} to transmit the image data. The display device 20 includes a power input terminal P2 and an image input terminal Q2. The power input terminal P2 is coupled to the socket 44 via the cable C_{AC2} to receive the power from the power line 30, and the image input terminal Q2 is coupled to the B2 terminal of the converter 34 via the cable C_{D2} to receive the image data provided by the electronic device 10. The converter 33 is plugged in the socket 41 via the A1 terminal, the converter 34 is plugged in the socket 42 via the B1 terminal, and the sockets 41 and 42 are connected to each other via the power line 30.

In the second embodiment of the invention, the converter 33 is a multiplexer and the converter 34 is a demultiplexer. Therefore, in the display system 300 of the invention, the converter 33 receives the image data sent by the electronic device 10, adds the image data to the power signal, and then transmits the power and the image data via the power line 30. In another aspect, the converter 34 receives and separates the power signal and the image data. Therefore, the converter can transmit the image data to the image input terminal Q2 of the display device 20. The invention is not limited to the embodiment in FIG. 3.

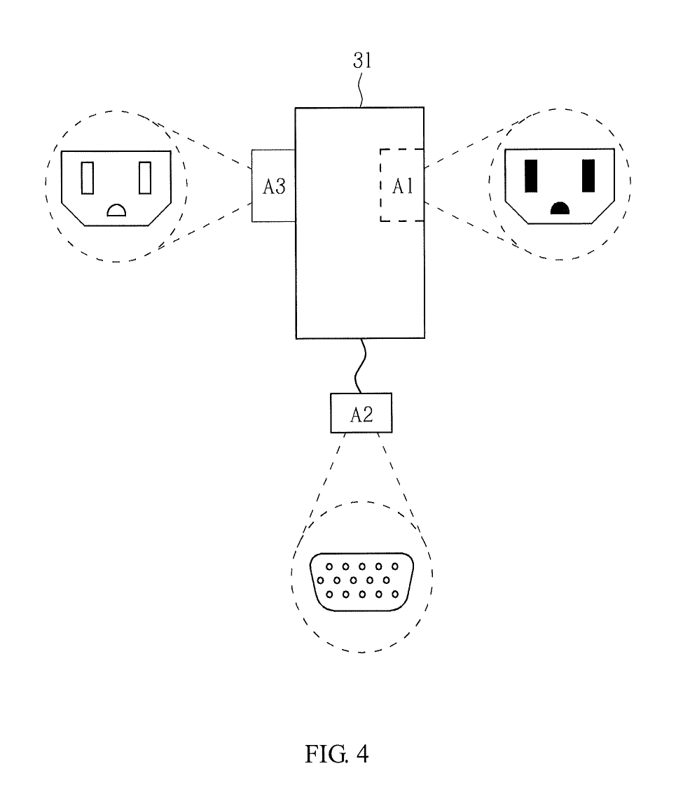

FIG. 4 is a schematic diagram showing the converter 31 in the first embodiment of the invention. In the embodiment, the display device 20 and the electronic device 10 send and receive multi-media information via an analog video interface, and thus the A2 terminal of the converters 31 may be set as a VGA terminal with 15 pins. According to the power supply specification of the power line 30, the A3 terminal of the converter 31 may be designed to be a B-type socket with three slots, and thus it allows the cable C_{AC1} to be plugged in. The A1 terminal of the converter 32 may be designed to be the B-type plug with three pins, and thus it may be plugged into the socket 41. According to the signal display specifications of the electronic device 10 and the display device 20 and the power supply systems in different districts, the Al to A3 terminals of converter 31 may be different. The invention is not limited to the embodiment in FIG. 4.

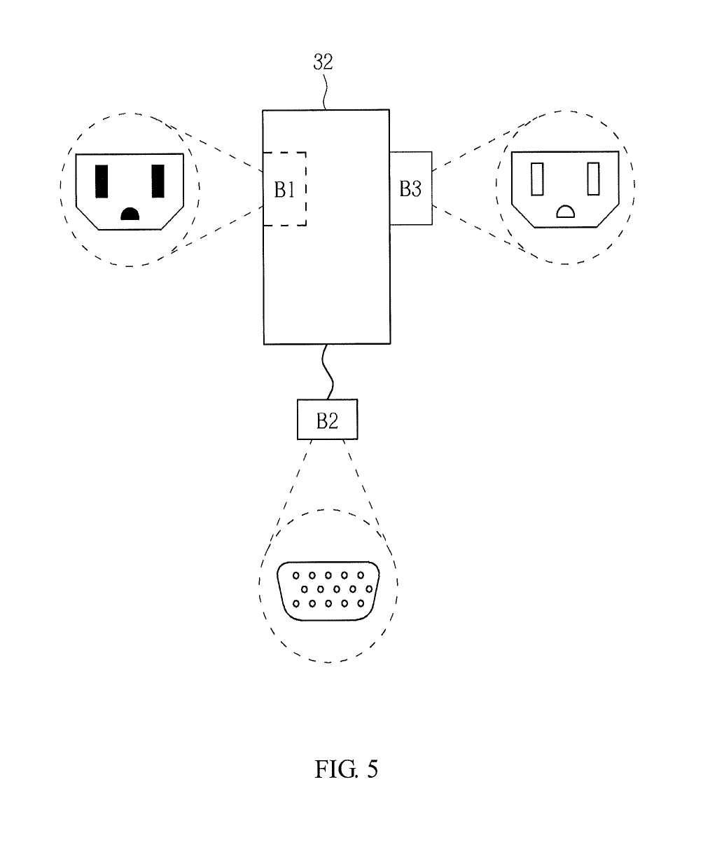

FIG. 5 is a schematic diagram showing the converter 32 in the first embodiment of the invention. In the embodiment, the electronic device 10 and the display device 20 send and receive multi-media information via the analog video interface, and the B2 terminal of the converter 32 may be designed as a D-sub terminal with 15 pins. The B1 terminal and B3 terminal of the converter 32 may be correspondingly designed according to the power supply specification of the power line 30. For example, the B3 terminal of the converter 32 may be designed to be a B-type socket with three slots, and thus it allows the cable C_{AC2} to be plugged in. The B1 terminal of the converter 31 may be designed to be the B-type plug with three pins, and it may be plugged into the socket 42. According to the signal display specifications of the display device 20 and the electronic device 10 and the power supply system in different districts, the B1 to B3 terminals of converter 32 can be different. The invention is not limited to the embodiment in FIG. 5.

In another aspect, the structure of the converter 33 in the second embodiment is similar to that of the converter 31 in the first embodiment of the invention, and the structure of the converter 34 in the second embodiment is similar to that of the converter 32 in the first embodiment of the invention. Therefore, they are not illustrated herein again for concise purpose.

In the invention, the display system uses a power line to transmit power and image data, and then transmits the image data to the display device after the converter separates the power and the image data. Therefore, an extension cable is not needed in transmitting image signals. In the invention, the display system is easy to be laid, and the signal quality would not be reduced due to the signal attenuation.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A display system comprising:
an electronic device for outputting image data;
a first converter plugged in a first socket and coupled to the electronic device for receiving image data sent by the electronic device and adding the image data to a power line to transmit the image data via the power line;
a second converter plugged in the second socket for receiving power and image data transmitted from the power line, separating the power and the image data, and outputting the image data; and
a display device coupled to the second converter for receiving the image data outputted from the second converter and displaying the image data.

2. The display system according to claim 1, wherein the first converter comprises:
a first terminal coupled to the first socket for receiving the power from the power line;
a second terminal for receiving the image data; and
a third terminal for outputting a power signal.

3. The display system according to claim 2, wherein the first terminal of the first converter comprises a first plug.

4. The display system according to claim 1, wherein the second converter comprises:
a first terminal coupled to the second socket for receiving the power from the power line;
a second terminal for outputting the image data; and
a third terminal for outputting a power signal.

5. The display system according to claim 1, wherein the first terminal of the second converter comprises a first plug.

6. The display system according to claim 4, wherein the second terminal of the first converter and the second terminal of the second converter comprise D-sub interfaces, respectively, and the electronic device and the display device receives and sends image data via the D-sub interface.

7. The display system according to claim 1, wherein the first converter comprises a multiplexer for combining the image data and the power, and transmitting the image data and the power to the second converter via the power line.

8. The display system according to claim 1, wherein the second converter comprises a demultiplexer for receiving the image data and the power transmitted from the power line and separating the image data and the power.

9. The display system according to claim 1, wherein the first socket and the second socket are sockets with different types, and the first socket and the second socket are connected to each other via the power line.
